(19) United States
(12) Patent Application Publication
(10) Pub. No.: US 2014/0301712 A1
(43) Pub. Date: Oct. 9, 2014

(54) PLAYER INTERATION METHOD AND DEVICE, TELEVISION SET, AND PLAYING APPARATUS

(71) Applicant: SHENZHEN SKYWORTH-RGB ELECTRONICS CO. LTD., Shenzhen (CN)

(72) Inventors: Zhi-Guo Wang, Shenzhen (CN); Xian-Hui Zeng, Shenzhen (CN); Rong Shen, Shenzhen (CN); Jia Liu, Ning An (CN); Ming Chen, Shenzhen (CN)

(73) Assignee: SHENZHEN SKYWORTH-RGB ELECTRONICS CO. LTD., Shenzhen (CN)

(21) Appl. No.: 14/176,645

(22) Filed: Feb. 10, 2014

(30) Foreign Application Priority Data
Apr. 8, 2013 (CN) 201310119687.6

(51) Int. Cl. G11B 19/02

(52) U.S. Cl. CPC G11B 19/027
USPC 386/234

(57) ABSTRACT

The invention relates to a player interaction method and device, a television, and a playing apparatus. The method includes detecting a trigger event generated through a control button on a remote control or on a player by a user; and determining a current page display status, and according to the trigger event and the page display status, linking to a corresponding display for displaying, and executing a corresponding play event. The device includes a detection module and a determination module. The television and the playing apparatus include the interaction device. According to the invention, a type of a detected trigger event is determined, and a corresponding display is linked to according to a current page display status for displaying, thereby making it easier for a user to perform identification, and reducing the operation complexity.

### CROSS-REFERENCE TO RELATED APPLICATION

This application claims the priority to Chinese Patent Application No. CN201310119687.6, filed on Apr. 8, 2013, in the State Intellectual Property Office of P.R. China, which is hereby incorporated herein in its entirety by reference.

### FIELD OF THE INVENTION

The present invention relates generally to the field of home appliances, and more particularly to a player interaction method and device, a television set, and a playing apparatus.

### BACKGROUND OF THE INVENTION

As the Internet and other technologies develop, resources such as videos, audios, and pictures are increasingly rich. In order to share the video, audio, and picture resources to make people enjoy the rich video, audio, and picture resources conveniently and quickly, it becomes an inevitable manner to view video, audio, and picture resources through a player.

Currently, a remote control is used as a medium to control a player to achieve viewing, which specifically adopts the following method. A preset trigger operation is designed, triggering is performed through a remote control, and a focus is constantly moved according to types of triggers to realize interaction with the player.

However, regarding an interaction method for controlling a player in the prior art, an interaction interface has too many buttons, which makes identification and selection difficult when a user performs play control, and operations are complicated.

Therefore, a heretofore unaddressed need exists in the art to address the aforementioned deficiencies and inadequacies.

### SUMMARY OF THE INVENTION

One of the objectives of the present invention is to provide a player interaction method and device, a television, and a playing apparatus to solve the problems in the prior art that a player interaction interface has too many buttons, it is difficult for a user to perform identification during play control, and the operation is complicated.

In one aspect of the invention, a player interaction includes detecting a trigger event generated through a control button on a remote control or on a player by a user; and determining a current page display status, and executing a corresponding play event according to the trigger event and the page display status.

In one embodiment, the step of determining the current page display status, and executing the corresponding play event according to the trigger event and the page display status specifically includes: determining the current page display status; when the page status is a home page display status, according to a current play mode, determining a play event, displaying a classification in a floating manner, and linking to preview display or list display according to the trigger event; when the page status is a preview display status, according to the trigger event, determining that the current play event displays in a preview area a brief information picture of a content corresponding to a classification triggered by the trigger event; and when the page status is a list display status, according to a list, displaying a content corresponding to a classification triggered by the trigger event.

In one embodiment, the method further includes according to a preset time interval, if no operation command is received, hiding a home page being displayed; and after the player receives a command for invoking the home page, showing a status bar; when a command for playing music, a movie, or a picture is received, hiding the status bar; after a command for closing the home page is received, closing the status bar, and displaying a current prompt, a progress bar, time, and a title of an audio played in the background on the status bar.

In one embodiment, the step of detecting the trigger event generated through the control button on the remote control or on the player by the user specifically includes: detecting a trigger generated through the control button on the remote control or on the player by the user; and determining a corresponding play event according to a position in which the trigger is generated, a current play mode, and a current play status.

In another aspect of the invention, a player interaction device includes a detection module, used for detecting a trigger event generated through a control button on a remote control or on a player by a user; and a determination module, used for determining a current page display status, and executing a corresponding play event according to the trigger event and the page display status.

In one embodiment, the determination module specifically includes a processing unit, used for determining the current page display status; a home page display unit, used for, when the page status is a home page display status, according to a current play mode, determining a play event, displaying a classification in a floating manner, and linking to preview display or list display according to the trigger event; a preview display unit, used for, when the page status is a preview display status, according to the trigger event, determining that the current play event displays in a preview area a brief information picture of a content corresponding to a classification triggered by the trigger event; and a list display unit, used for, when the page status is a list display status, according to a list, displaying a content corresponding to a classification triggered by the trigger event.

In one embodiment, the device further includes a hiding module, used for, according to a preset time interval, if no operation command is received, hiding a home page being displayed; and a processing module, used for, after the player receives a command for invoking the home page, showing a status bar; when a command for playing music, a movie, or a picture is received, hiding the status bar; after a command for closing the home page is received, closing the status bar, and displaying a current prompt, a progress bar, time, and a title of an audio played in the background on the status bar.

In one embodiment, the detection module is specifically used for detecting a trigger generated through the control button on the remote control or on the player by the user, and determining a corresponding play event according to a position where the trigger is generated, a current play mode, and a current play status.

In yet another aspect, a television including the interaction device is provided.

In a further aspect, a playing apparatus including the interaction device is provided.

In yet a further aspect, the invention relates to a non-transitory computer-readable medium storing instructions which, when executed by one or more processors, cause the above-disclosed television and/or playing apparatus to perform the foregoing method.

The technical solutions provided by the embodiments of the present invention have the following beneficial effects. A type of a detected trigger event is determined, and a corresponding display is linked to according to a current page display status for displaying, thereby making it easier for a user to perform identification, and reducing user operation complexity.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a flow chart of a player interaction method provided by Embodiment 1 of the present invention.

FIG. 2 is a detailed flow chart of Step 102 in Embodiment 1.

FIG. 3 is a schematic display view of a video mode in a home page display status.

FIG. 4 is a schematic display view of an audio mode in a home page display status.

FIG. 5 is a schematic display view of a picture mode in a home page display status.

FIG. 6 is a schematic view of brief information of videos in a preview display status.

FIG. 7 is a schematic view of brief information of audios in a preview display status.

FIG. 8 is a schematic view of brief information of pictures in a preview display status.

FIG. 9 is a schematic view of a play list corresponding to audio and video classifications.

FIG. 10 is a schematic view of a play list corresponding to a picture classification.

FIG. 11 is a schematic view of a remote control.

FIG. 12 is a schematic structural view of a player interaction device provided by Embodiment 2 of the present invention. FIG. 13 is a schematic structural view of another player interaction device provided by Embodiment 2 of the present invention.

### DETAILED DESCRIPTION OF THE INVENTION

The present disclosure will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are configured to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, although the terms first, second, third etc. may be used herein to describe various elements, components, regions, layers and/or sections, these elements, components, regions, layers and/or sections should not be limited by these terms. These terms are only configured to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

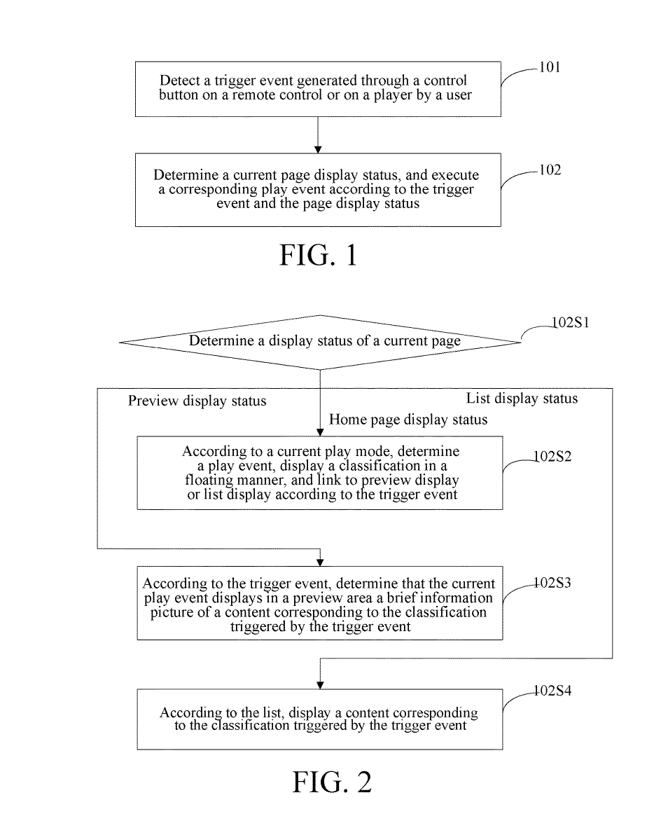

The description will be made as to the embodiments of the present disclosure in conjunction with the accompanying drawings in FIGS. 1-13. It should be understood that specific embodiments described herein are merely used for explaining the invention, but are not intended to limit the invention. In accordance with the purposes of this disclosure, as embodied and broadly described herein, this invention, in one aspect, relates to a player interaction method and device, a television set, and a playing apparatus.

### Embodiment 1

Referring to FIG. 1, the embodiment of the present invention provides a player interaction method, an implementing subject of the method is a player terminal having a remote control function, and the method includes the following steps.

Step 101: Detect a trigger event generated through a control button on a remote control or on a player by a user.

The trigger event refers to a trigger event corresponding triggering of a trigger position on a remote control. For example, the user presses “Ok” and “Return” on the remote control to generate different trigger events respectively.

Step 102: Determine a current page display status, and execute a corresponding play event according to the trigger event and the page display status.

The page status includes a home page display status, a preview display status, and a list display status.

Optionally, in the embodiment, the method may further include: according to a preset time interval, if no operation command is received, hiding a home page being displayed; and after the player receives a command for invoking the home page, showing a status bar; when a command for playing music, a movie, or a picture is received, hiding the status bar; after a command for closing the home page is received, closing the status bar, and displaying a current prompt, a progress bar, time, and a title of an audio played in the background on the status bar.

With reference to the embodiment, referring to FIG. 2, Step 102 specifically includes the following steps.

Step 102S1: Determine a display status of a current page, and when the page status is the home page display status, execute Step 102S2; when the page status is the preview display status, execute Step 102S3; when the page status is the list display status, execute Step 102S4.

Step 102S2: According to a current play mode, determine a play event, display a classification in a floating manner, and link to preview display or list display according to the trigger event.

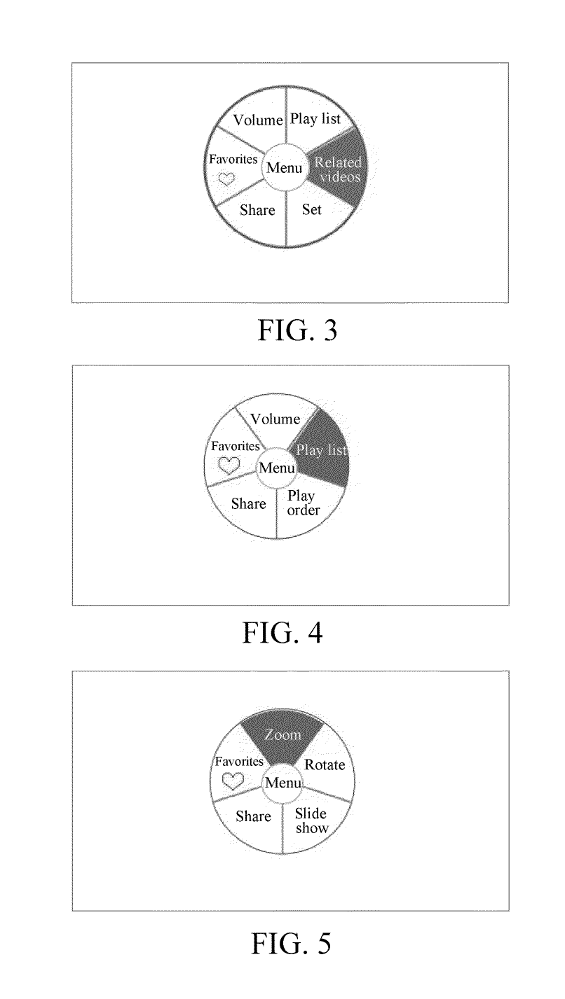

The play mode includes a video play mode, an audio play mode, and a picture play mode. In the home page display status, if the current play mode is the video play mode, as shown in FIG. 3, Menu, Favorites, Share, Set, Related videos, Play list, Volume are included; if the current play mode is the audio play mode, as shown in FIG. 4, Menu, Favorites, Share, Play order, Play list, and Volume are included; if the current play mode is the picture play mode, as shown in FIG. 5, Menu, Favorites, Share, Slide show, Rotate, and Zoom are included.

Further, it should be noted that the display manner is the floating manner.

Step 102S3: According to the trigger event, determine that the current play event displays in a preview area a brief information picture of a content corresponding to the classification triggered by the trigger event.

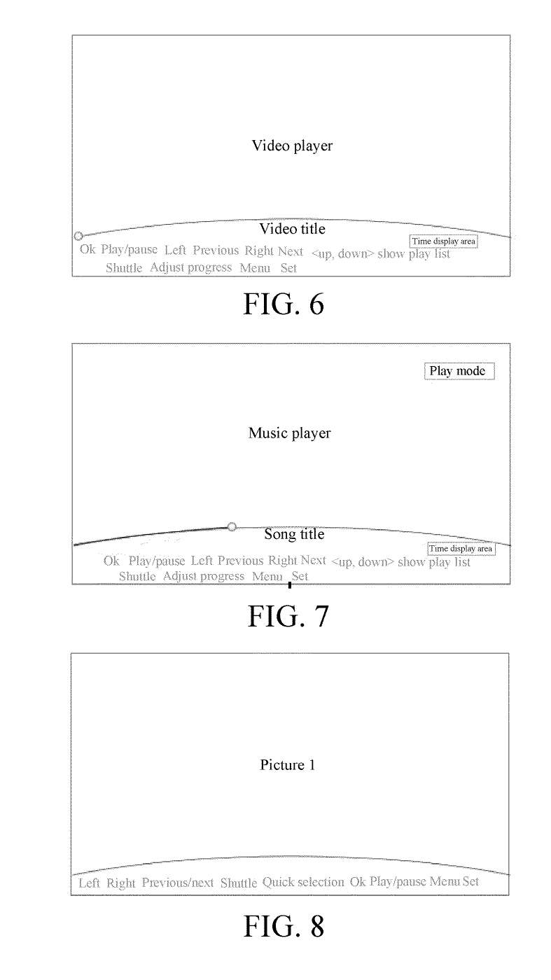

The classification mainly includes video, audio, and picture. The user can directly access brief information of all “videos”, “audios”, and “pictures”. A brief information picture of videos, as shown in FIG. 6, includes a video player, a video title, operation guide display, time display, and other information. A brief information picture of audios, as shown in FIG. 7, includes contents such as a singer, a song name, lyrics, a play mode, a song title, volume, operation guide display, and time display. A brief information picture of pictures, as shown in FIG. 8, includes a picture content and operation guide display.

Step 102S4: According to the list, display a content corresponding to the classification triggered by the trigger event.

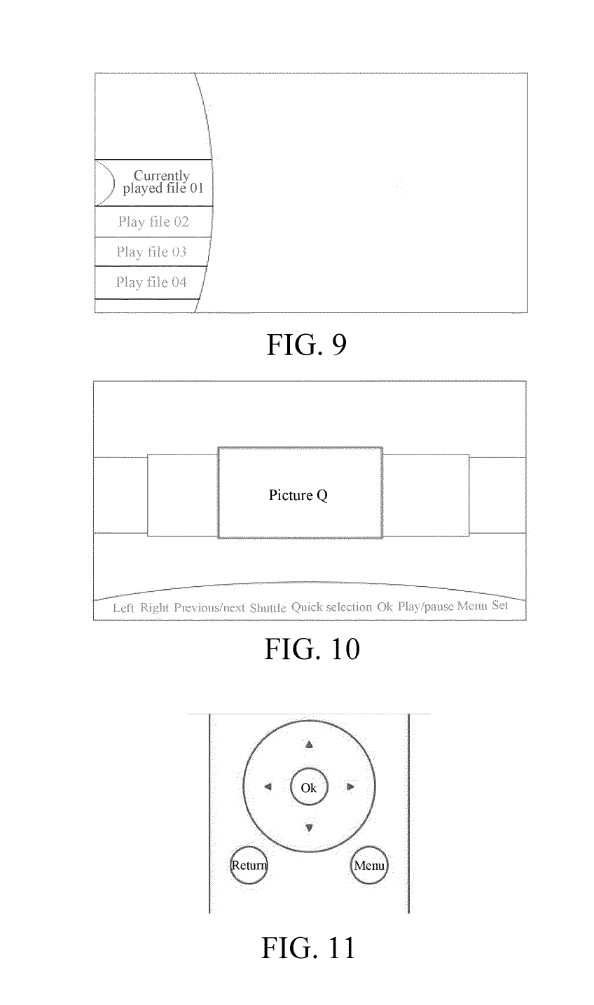

The classification mainly includes video, audio, and picture. A play list corresponding to the video and audio classifications is shown in FIG. 9. A list corresponding to the picture classification is arranged in a row, as shown in FIG. 10.

Further, in Step 101 of the embodiment where the trigger event generated through the control button on the remote control or on the player by the user is detected, an interface of the remote control, as shown in FIG. 11, includes buttons of “Ok”, “Return”, “Menu”, “Up”, “Down”, “Left”, and “Right”.

Further, in Step 101, the trigger event is determined according to the trigger position, the current play mode, and the current play status, and preset play control information is obtained according to the trigger event. The determining the trigger event according to the detected trigger position may include, but not limited to, the following seven situations.

### Situation 1

Situation 1 specifically includes the following steps.

Step 11S1: When it is detected that the trigger position that generates the trigger is a first trigger position, determine the current play status; if the current play status is a pause status, execute Step 11S2; if the current play status is a playing status, execute Step 11S3; if the current play status is a set status, execute Step 11S4.

The first trigger position is triggered by the “Ok” button.

Step 11S2: Determine that the trigger event is a play event, and according to a play event flag, obtain play information corresponding to the play event from the preset play control information, so as to play a video.

For example, during viewing of a played video, the user addresses a high-level situation, which pauses the video playing, and when the video needs to be played again, it is detected that the user presses the “Ok” button, so as to continue to play the paused video.

Step 11S3: Determine that the trigger event is a pause event, and according to a pause event flag, obtain pause information corresponding to the pause event from the preset play control information, so as to pause a video.

For example, during viewing of a played video, the user may press the “Ok” button to generate a trigger when a high-level situation needs to be addressed.

Step 11S4: Determine that the trigger event is a confirm event, and according to a confirm event flag, obtain confirm information corresponding to the confirm event from the preset play control information, so as to confirm a currently set event.

It should be noted that, Steps 11S1-11S4 may be executed in any play mode.

### Situation 2

Situation 2 specifically includes the following steps.

Step 12S1: When it is detected that the trigger position that generates the trigger is a second trigger position, determine the current play status and the current play mode; if the current play status is a play status or a pause status, and the current play mode is a video mode, execute Step 12S2; if the current play status is a play status or a pause status, and the current play mode is an audio mode, execute Step 12S3; if the current play status is a play status or a pause status, and the current play mode is a picture mode, execute Step 12S4; if the current play status is a set status and the current play mode is any play mode, execute Step 12S5.

The second trigger position is triggered by the “Left” button.

Step 12S2: Determine that the trigger event is a fast-backward event, and according to a fast-backward event flag, obtain fast-backward information corresponding to the fast-backward event from the preset play control information, so as to implement the fast-backward event.

Step 12S3: Determine that the trigger event is a previous-song event, and according to a previous-song event flag, obtain previous-song information corresponding to the previous-song event from the preset play control information, so as to implement a play-previous-song event.

Step 12S4: Determine that the trigger event is a previous-picture event, and according to a previous-picture event flag, obtain previous-picture information corresponding to the previous-picture event from the preset play control information, so as to implement a view-previous-picture event.

Step 12S5: Determine that the trigger event is a LEFT event, and according to a LEFT event flag, obtain LEFT information corresponding to the LEFT event from the preset play control information, so as to implement the LEFT event.

### Situation 3

Situation 3 specifically includes the following steps.

Step 13S1: When it is detected that the trigger position that generates the trigger is a third trigger position, determine the current play status and the current play mode; if the current play status is a play status or a pause status, and the current play mode is a video mode, execute Step 13S2; if the current play status is a play status or a pause status, and the current play mode is an audio mode, execute Step 13S3; if the current play status is a play status or a pause status, and the current play mode is a picture mode, execute Step 13S4; if the current play status is a set status and the current play mode is any play mode, execute

Step 13S5.

The third trigger position is triggered by the “Right” button.

Step 13S2: Determine that the trigger event is a fast-forward event, and according to a fast-forward event flag, obtain fast-forward information corresponding to the fast-forward event from the preset play control information, so as to implement the fast-forward event.

Step 13S3: Determine that the trigger event is a next-song event, and according to a next-song event flag, obtain next-song information corresponding to the next-song event from the preset play control information, so as to implement a play-next-song event.

Step 13S4: Determine that the trigger event is a next-picture event, and according to a next-picture event flag, obtain next-picture information corresponding to the next-picture event from the preset play control information, so as to implement a view-next-picture event.

Step 13S5: Determine that the trigger event is a RIGHT event, and according to a RIGHT event flag, obtain RIGHT information corresponding to the RIGHT event from the preset play control information, so as to implement the RIGHT event.

### Situation 4

When it is detected that the trigger position that generates the trigger is a fourth trigger position, determine that the current trigger event is a play list event, obtain a corresponding play list from the preset play control information according to a play list event flag and the current play mode, display the play list, and wait for detection of a next trigger.

The fourth trigger position is triggered by the “Up” button.

### Situation 5

When it is detected that the trigger position that generates the trigger is a fifth trigger position, determine that the current trigger event is a status event, obtain corresponding status information from the preset play control information according to a status event flag, and display the status information.

The fifth trigger position is triggered by the “Down” button.

### Situation 6

When it is detected that the trigger position that generates the trigger is a sixth trigger position, determine that the current trigger event is a menu trigger event, obtain corresponding menu information from the preset play control information according to a menu trigger event flag and the current play mode, display the menu information, and wait for detection of a next trigger.

The sixth trigger position is triggered by the “Menu” button.

### Situation 7

When it is detected that the trigger position that generates the trigger is a seventh trigger position, determine that the current trigger event is a return trigger event, obtain return information from the preset play control information according to a return trigger event flag and the current play mode, interrupt the current play, and return a previous play status.

The seventh trigger position is triggered by the “Return” button.

In Embodiment 1 of the present invention, the type of the detected trigger event is determined, a corresponding display is linked to according to the current page display status for displaying, and the floating display manner is adopted, thereby making it easier for a user to perform identification, making it convenient for a user to perform selection, and reducing user operation complexity.

### Embodiment 2

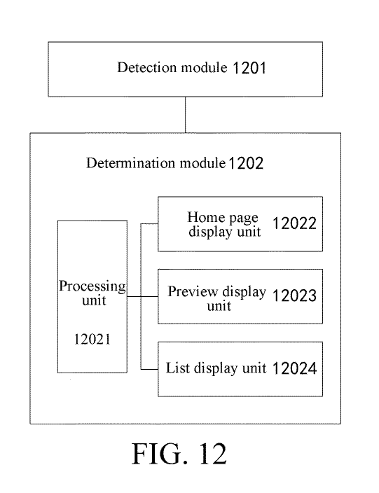

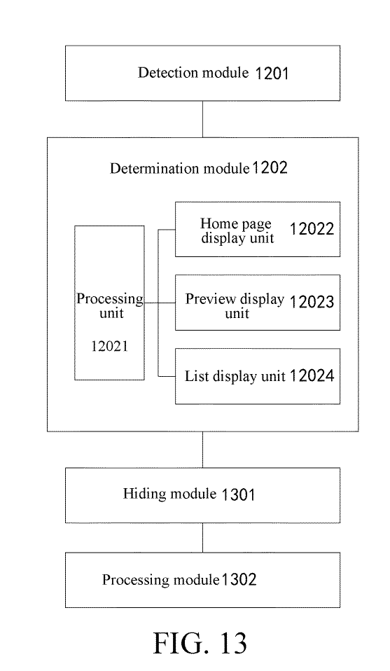

Referring to FIG. 12, the embodiment of the present invention provides a player interaction device. The device includes: a detection module 1201 and a determination module 1202.

The detection module 1201 is used for detecting a trigger event generated through a control button on a remote control or on a player by a user.

The detection module 1201 is specifically used for detecting a trigger generated through the control button on the remote control or on the player by the user, and determining a corresponding play event according to a position where the trigger is generated, a current play mode, and a current play status.

The determination module 1202 is used for determining a current page display status, and executing the corresponding play event according to the trigger event and the page display status.

The determination module specifically includes a processing unit 12021, used for determining the current page display status; a home page display unit 12022, used for, when the page status is a home page display status, according to the current play mode, determining a play event, displaying a classification in a floating manner, and linking to preview display or list display according to the trigger event; a preview display unit 12023, used for, when the page status is a preview display status, according to the trigger event, determining that the current play event displays in a preview area a brief information picture of a content corresponding to the classification triggered by the trigger event; and a list display unit 12024, used for, when the page status is a list display status, according to the list, displaying a content corresponding to the classification triggered by the trigger event.

With reference to the device, the present invention provides another player interaction device, which, as shown in FIG. 13, further includes:

a hiding module 1301, used for, according to a preset time interval, if no operation command is received, hiding a home page being displayed; and

a processing module 1302, used for, after the player receives a command for invoking the home page, showing a status bar; when a command for playing music, a movie, or a picture is received, hiding the status bar; after a command for closing the home page is received, closing the status bar, and displaying a current prompt, a progress bar, time, and a title of an audio played in the background on the status bar.

In view of the above, in the embodiment of the present invention, the detection module detects the trigger event, and displaying is performed according to the type of the trigger event and the current page status in a floating display manner, thereby making it easier for a user to perform identification, making it convenient for a user to perform selection, and reducing user operation complexity.

Embodiments of the present invention further provide a television set and a playing apparatus including the interaction device.

It should be noted that, according to the embodiment, for the player interaction device in the player, examples of division of functional modules are provided for illustration, and in actual applications, the functions may be allocated to different functional modules according to needs, that is, the internal structure of the device is divided into different functional modules to implement all or part of the functions described above.

The player interaction device provided by the embodiment is based on the same concept as the embodiment of the player interaction method, and specific implementation thereof may be referred to the method embodiment, and is not repeated herein.

The sequence numbers of the embodiments of the present invention are merely for description purpose but do not indicate the preference of the embodiments.

It should be noted that all or a part of the steps according to the embodiments of the invention is implemented by hardware or a program instructing relevant hardware. Yet another aspect of the invention provides a non-transitory computer readable storage medium which stores computer executable instructions or program codes. The computer executable instructions or program codes enable one or more processors to complete various operations in the above disclosed method. The storage medium includes, but not limited to, a magnetic disk, an optical disk, a read-only memory (ROM), a random access memory (RAM), random memory (RAM), flash dive, or the likes.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A player interaction method, comprising:
detecting a trigger event generated through a control button on a remote control or on the player by a user; and
determining a current page display status, and executing a corresponding play event according to the trigger event and the page display status.

2. The method according to claim 1, wherein the step of determining the current page display status, and executing the corresponding play event according to the trigger event and the page display status specifically comprises:
determining the current page display status;
when the page status is a home page display status, according to a current play mode, determining a play event, displaying a classification in a floating manner, and linking to preview display or list display according to the trigger event;
when the page status is a preview display status, according to the trigger event, determining that the current play event displays in a preview area a brief information picture of a content corresponding to a classification triggered by the trigger event; and
when the page status is a list display status, according to a list, displaying a content corresponding to a classification triggered by the trigger event.

3. The method according to claim 1, further comprising:
according to a preset time interval, if no operation command is received, hiding a home page being displayed; and
after the player receives a command for invoking the home page, showing a status bar; when a command for playing music, a movie, or a picture is received, hiding the status bar; after a command for closing the home page is received, closing the status bar, and displaying a current prompt, a progress bar, time, and a title of an audio played in the background on the status bar.

4. The method according to claim 1, wherein the step of detecting the trigger event generated through the control button on the remote control or on the player by the user specifically comprises:
detecting a trigger generated through the control button on the remote control or on the player by the user; and
determining a corresponding play event according to a position in which the trigger is generated, a current play mode, and a current play status.

5. A player interaction device, comprising:
a detection module, used for detecting a trigger event generated through a control button on a remote control or on a player by a user; and
a determination module, used for determining a current page display status, and executing a corresponding play event according to the trigger event and the page display status.

6. The device according to claim 5, wherein the determination module comprises:
a processing unit, used for determining the current page display status;
a home page display unit, used for, when the page status is a home page display status, according to a current play mode, determining a play event, displaying a classification in a floating manner, and linking to preview display or list display according to the trigger event;
a preview display unit, used for, when the page status is a preview display status, according to the trigger event, determining that the current play event displays in a preview area a brief information picture of a content corresponding to a classification triggered by the trigger event; and
a list display unit, used for, when the page status is a list display status, according to a list, displaying a content corresponding to a classification triggered by the trigger event.

7. The device according to claim 5, further comprising:
a hiding module, used for, according to a preset time interval, if no operation command is received, hiding a home page being displayed; and
a processing module, used for, after the player receives a command for invoking the home page, showing a status bar; when a command for playing music, a movie, or a picture is received, hiding the status bar; after a command for closing the home page is received, closing the status bar, and displaying a current prompt, a progress bar, time, and a title of an audio played in the background on the status bar.

8. The device according to claim 5, wherein the detection module is specifically used for detecting a trigger generated through the control button on the remote control or on the player by the user, and determining a corresponding play event according to a position in which the trigger is generated, a current play mode, and a current play status.

9. A playing apparatus, comprising the player interaction device according to claim 5.

10. A television, comprising:
a player interaction device comprising:
a detection module, used for detecting a trigger event generated through a control button on a remote control or on a player by a user; and
a determination module, used for determining a current page display status, and executing a corresponding play event according to the trigger event and the page display status.

11. The television according to claim 10, wherein the determination module comprises:
a processing unit, used for determining the current page display status;
a home page display unit, used for, when the page status is a home page display status, according to a current play mode, determining a play event, displaying a classification in a floating manner, and linking to preview display or list display according to the trigger event;
a preview display unit, used for, when the page status is a preview display status, according to the trigger event, determining that the current play event displays in a preview area a brief information picture of a content corresponding to a classification triggered by the trigger event; and
a list display unit, used for, when the page status is a list display status, according to a list, displaying a content corresponding to a classification triggered by the trigger event.

12. The television according to claim 10, wherein the player interaction device further comprises:
a hiding module, used for, according to a preset time interval, if no operation command is received, hiding a home page being displayed; and
a processing module, used for, after the player receives a command for invoking the home page, showing a status bar; when a command for playing music, a movie, or a picture is received, hiding the status bar; after a command for closing the home page is received, closing the status bar, and displaying a current prompt, a progress bar, time, and a title of an audio played in the background on the status bar.

13. The television according to claim 10, wherein the detection module is specifically used for detecting a trigger generated through the control button on the remote control or on the player by the user, and determining a corresponding play event according to a position in which the trigger is generated, a current play mode, and a current play status.

14. A non-transitory computer-readable medium storing instructions which, when executed by one or more processors, cause a television and/or a playing apparatus to perform a player interaction method, wherein the method comprises:
detecting a trigger event generated through a control button on a remote control or on the player by a user; and
determining a current page display status, and executing a corresponding play event according to the trigger event and the page display status.

15. The non-transitory computer-readable medium according to claim 14, wherein the step of determining the current page display status, and executing the corresponding play event according to the trigger event and the page display status specifically comprises:
determining the current page display status;
when the page status is a home page display status, according to a current play mode, determining a play event, displaying a classification in a floating manner, and linking to preview display or list display according to the trigger event;
when the page status is a preview display status, according to the trigger event, determining that the current play event displays in a preview area a brief information picture of a content corresponding to a classification triggered by the trigger event; and
when the page status is a list display status, according to a list, displaying a content corresponding to a classification triggered by the trigger event.

16. The non-transitory computer-readable medium according to claim 14, wherein the method further comprises:
according to a preset time interval, if no operation command is received, hiding a home page being displayed; and
after the player receives a command for invoking the home page, showing a status bar; when a command for playing music, a movie, or a picture is received, hiding the status bar; after a command for closing the home page is received, closing the status bar, and displaying a current prompt, a progress bar, time, and a title of an audio played in the background on the status bar.

17. The non-transitory computer-readable medium according to claim 14, wherein the step of detecting the trigger event generated through the control button on the remote control or on the player by the user specifically comprises:
detecting a trigger generated through the control button on the remote control or on the player by the user; and
determining a corresponding play event according to a position in which the trigger is generated, a current play mode, and a current play status.
